(19) United States
(12) Patent Application Publication
(10) Pub. No.: US 2023/0180252 A1
(43) Pub. Date: Jun. 8, 2023

(54) PRECODING MATRIX INDICATION FOR PHYSICAL UPLINK SHARED CHANNEL REPETITIONS

(71) Applicant: QUALCOMM Incorporated, San Diego, CA (US)

(72) Inventors: Mostafa KHOSHNEVISAN, San Diego, CA (US); Yitao CHEN, San Diego, CA (US); Xiaoxia ZHANG, San Diego, CA (US); Tao LUO, San Diego, CA (US); Fang YUAN, Beijing (CN)

(21) Appl. No.: 18/041,654

(22) PCT Filed: Oct. 3, 2020
(86) PCT No.: PCT/CN2020/119800

§ 371 Date: Feb. 14, 2023

(51) Int. Cl. H04W 72/23; H04B 7/06; H04L 1/08; H04W 72/1268; H04L 5/00

(52) U.S. Cl. CPC H04W 72/23; H04B 7/0639; H04L 1/08; H04W 72/1268; H04L 5/0051

(57) ABSTRACT

Various aspects of the present disclosure generally relate to wireless communication. In some aspects, a user equipment (UE) may receive a downlink control information (DCI) message that includes a first field indicating a first transmit precoder matrix indicator (TPMI) index and a quantity of transmission layers and a second field indicating a second TPMI index. The UE may determine a first precoding matrix for transmitting a first set of repetitions of a physical uplink shared channel (PUSCH) transmission based at least in part on the first TPMI index and the quantity of transmission layers, and a second precoding matrix for transmitting a second set of repetitions of the PUSCH transmission based at least in part on the second TPMI index and the quantity of transmission layers. Numerous other aspects are provided.

### FIELD OF THE DISCLOSURE

Aspects of the present disclosure generally relate to wireless communication and to techniques and apparatuses for precoding matrix indication for physical uplink shared channel (PUSCH) repetitions.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes receiving a downlink control information (DCI) message that includes a first field indicating a first transmit precoder matrix indicator (TPMI) index and a quantity of transmission layers and a second field indicating a second TPMI index; and determining a first precoding matrix for transmitting a first set of repetitions of a physical uplink shared channel (PUSCH) transmission based at least in part on the first TPMI index and the quantity of transmission layers, and a second precoding matrix for transmitting a second set of repetitions of the PUSCH transmission based at least in part on the second TPMI index and the quantity of transmission layers.

In some aspects, a UE for wireless communication includes a memory and one or more processors operatively coupled to the memory, the memory and the one or more processors configured to: receive a DCI message that includes a first field indicating a first TPMI index and a quantity of transmission layers and a second field indicating a second TPMI index; and determine a first precoding matrix for transmitting a first set of repetitions of a PUSCH transmission based at least in part on the first TPMI index and the quantity of transmission layers, and a second precoding matrix for transmitting a second set of repetitions of the PUSCH transmission based at least in part on the second TPMI index and the quantity of transmission layers.

In some aspects, a non-transitory computer-readable medium storing a set of instructions for wireless communication includes one or more instructions that, when executed by one or more processors of a UE, cause the UE to: receive a DCI message that includes a first field indicating a first TPMI index and a quantity of transmission layers and a second field indicating a second TPMI index; and determine a first precoding matrix for transmitting a first set of repetitions of a PUSCH transmission based at least in part on the first TPMI index and the quantity of transmission layers, and a second precoding matrix for transmitting a second set of repetitions of the PUSCH transmission based at least in part on the second TPMI index and the quantity of transmission layers.

In some aspects, an apparatus for wireless communication includes means for receiving a DCI message that includes a first field indicating a first TPMI index and a quantity of transmission layers and a second field indicating a second TPMI index; and means for determining a first precoding matrix for transmitting a first set of repetitions of a PUSCH transmission based at least in part on the first TPMI index and the quantity of transmission layers, and a second precoding matrix for transmitting a second set of repetitions of the PUSCH transmission based at least in part on the second TPMI index and the quantity of transmission layers.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with various aspects of the present disclosure.

FIG. 2 is a diagram illustrating an example of a base station in communication with a UE in a wireless network, in accordance with various aspects of the present disclosure.

FIG. 3 is a diagram illustrating examples of physical uplink repetition types, in accordance with various aspects of the present disclosure.

FIG. 4 is a diagram illustrating an example of physical uplink repetitions, in accordance with various aspects of the present disclosure.

FIG. 5 is a diagram illustrating an example associated with precoding matrix indication for physical uplink shared channel (PUSCH) repetitions, in accordance with various aspects of the present disclosure.

FIG. 6 is a diagram illustrating an example process associated with precoding matrix indication for PUSCH repetitions, in accordance with various aspects of the present disclosure.

FIG. 7 is a diagram of an example apparatus for wireless communication, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

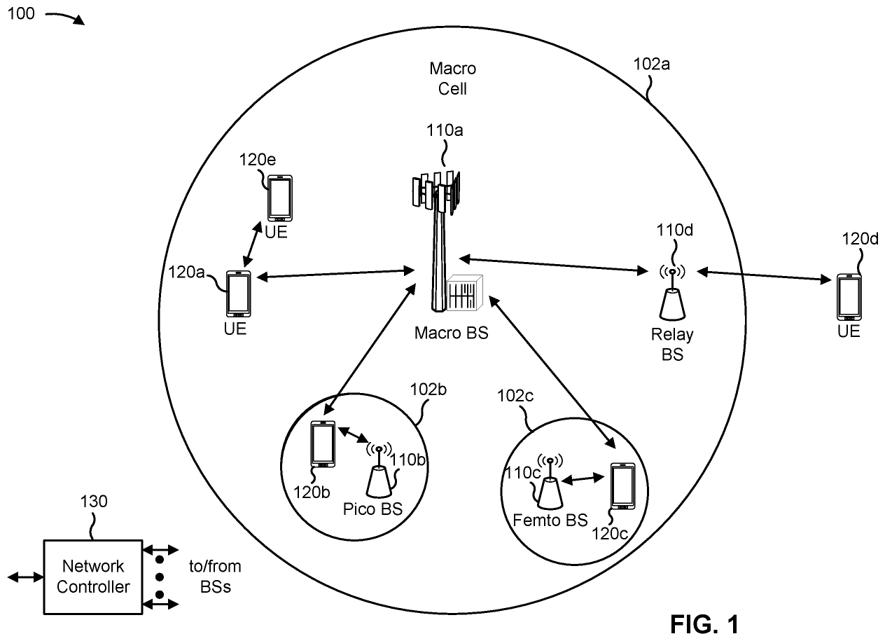

FIG. 1 is a diagram illustrating an example of a wireless network 100, in accordance with various aspects of the present disclosure. The wireless network 100 may be or may include elements of a 5G (NR) network, an LTE network, and/or the like. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. A BS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like. In some aspects, the processor components and the memory components may be coupled together. For example, the processor components (e.g., one or more processors) and the memory components (e.g., a memory) may be operatively coupled, communicatively coupled, electronically coupled, electrically coupled, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, and/or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

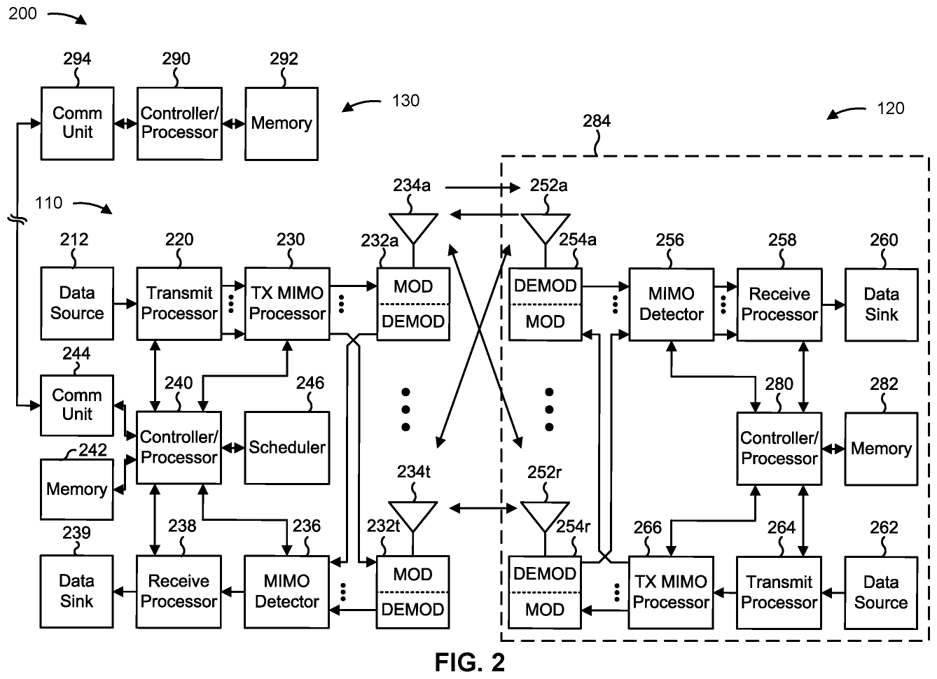

FIG. 2 is a diagram illustrating an example 200 of a base station 110 in communication with a UE 120 in a wireless network 100, in accordance with various aspects of the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., a cell-specific reference signal (CRS), a demodulation reference signal (DMRS), and/or the like) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

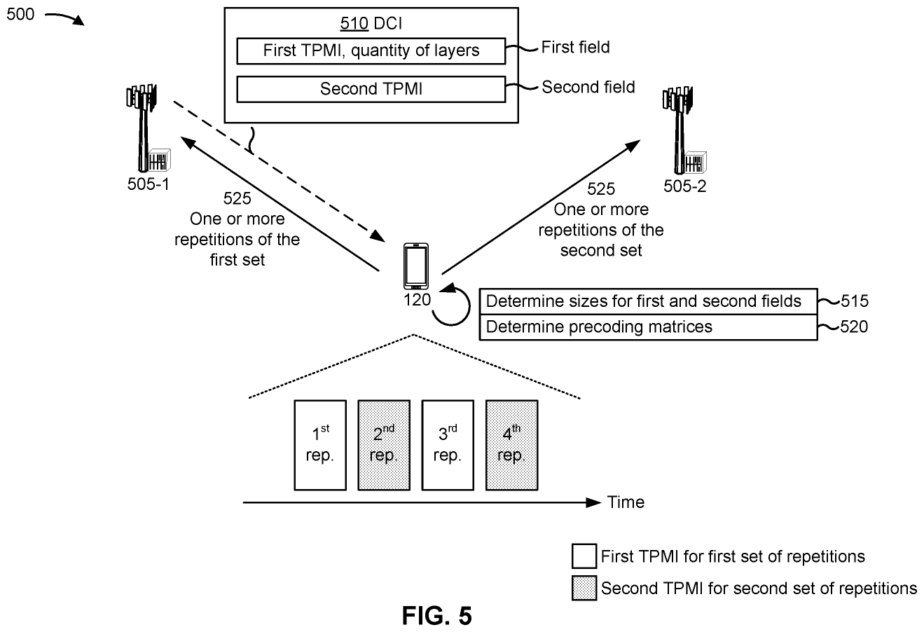

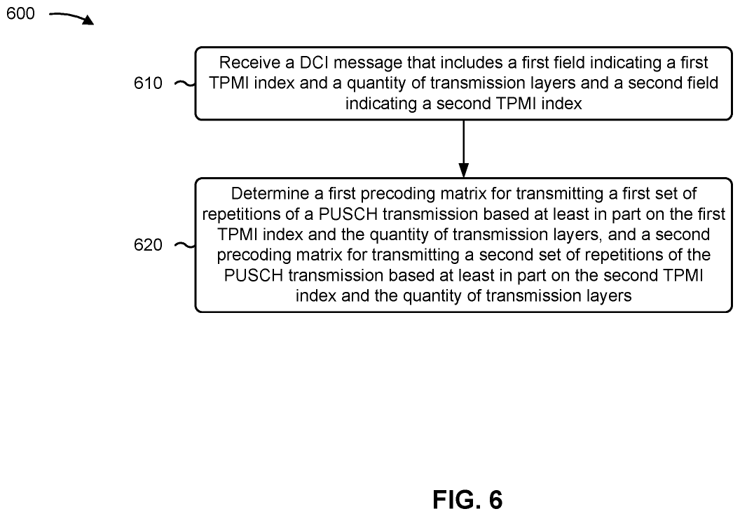

On the uplink, at UE 120, a transmit processor 264 may receive and process data from a data source 262 and control information (e.g., for reports that include RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 5-6.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 5-6.

Controller/processor 240 of base station 110, controller/processor 280 of UE 120, and/or any other component(s) of FIG. 2 may perform one or more techniques associated with precoding matrix indication for PUSCH repetitions, as described in more detail elsewhere herein. For example, controller/processor 240 of base station 110, controller/processor 280 of UE 120, and/or any other component(s) of FIG. 2 may perform or direct operations of, for example, process 600 of FIG. 6, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code, program code, and/or the like) for wireless communication. For example, the one or more instructions, when executed (e.g., directly, or after compiling, converting, interpreting, and/or the like) by one or more processors of the base station 110 and/or the UE 120, may cause the one or more processors, the UE 120, and/or the base station 110 to perform or direct operations of, for example, process 600 of FIG. 6, and/or other processes as described herein. In some aspects, executing instructions may include running the instructions, converting the instructions, compiling the instructions, interpreting the instructions, and/or the like.

In some aspects, the UE includes means for receiving a downlink control information (DCI) message that includes a first field indicating a first transmit precoder matrix indicator (TPMI) index and a quantity of transmission layers and a second field indicating a second TPMI index; and/or means for determining a first precoding matrix for transmitting a first set of repetitions of a PUSCH transmission based at least in part on the first TPMI index and the quantity of transmission layers, and a second precoding matrix for transmitting a second set of repetitions of the PUSCH transmission based at least in part on the second TPMI index and the quantity of transmission layers. The means for the UE to perform operations described herein may include, for example, antenna 252, demodulator 254, MIMO detector 256, receive processor 258, transmit processor 264, TX MIMO processor 266, modulator 254, controller/processor 280, and/or memory 282.

In some aspects, the UE includes means for transmitting one or more repetitions of the first set of repetitions using the first precoding matrix and one or more repetitions of the second set of repetitions using the second precoding matrix.

In some aspects, the UE includes means for determining a size of the second field based at least in part on the quantity of transmission layers indicated by the first field.

In some aspects, the UE includes means for determining a size of the second field based at least in part on a maximum quantity of bits used among multiple quantities of transmission layers for a quantity of PUSCH antenna ports for the PUSCH transmission.

In some aspects, the UE includes means for determining a size of the second field based at least in part on a maximum quantity of bits used among multiple quantities of transmission layers for a maximum quantity of ports configured for a sounding reference signal (SRS) resource of an SRS resource set configured for codebook usage.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

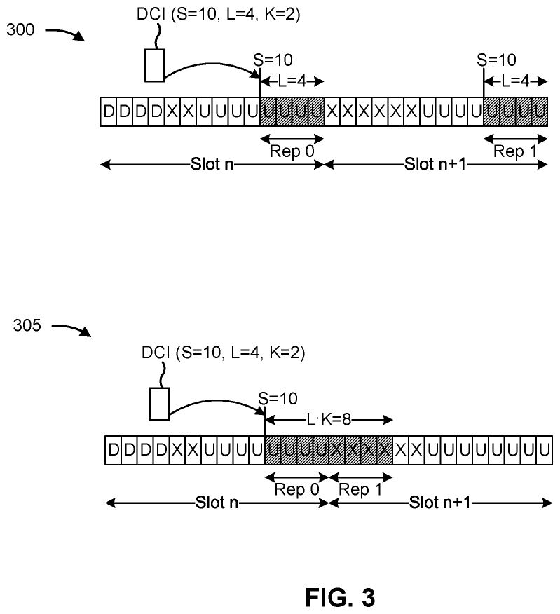

FIG. 3 is a diagram illustrating examples 300 and 305 of physical uplink repetition types, in accordance with various aspects of the present disclosure. In particular, examples 300 and 305 are examples of different types of PUSCH repetition, which may be used for dynamic grants or configured grants. The different types of PUSCH repetition of examples 300 and 305 may be used for ultra-reliable low-latency communication (URLLC). In some aspects, PUSCH repetitions may be defined according to a start and length indicator value (SLIV), which indicates a starting symbol (S) for a repetition and a length (L) of a repetition (e.g., a quantity of symbols for a repetition), and a quantity of repetitions (K).

Example 300 is an example of PUSCH repetition Type A. In PUSCH repetition Type A, the same SLIV may be used for each repetition in a slot across K consecutive slots (e.g., when K>1). PUSCH repetition Type A may use dynamic indication of the quantity of repetitions (e.g., in a time domain resource allocation (TDRA) field of DCI), or semi-static configuration of the quantity of repetitions (e.g., in a radio resource control (RRC) configuration).

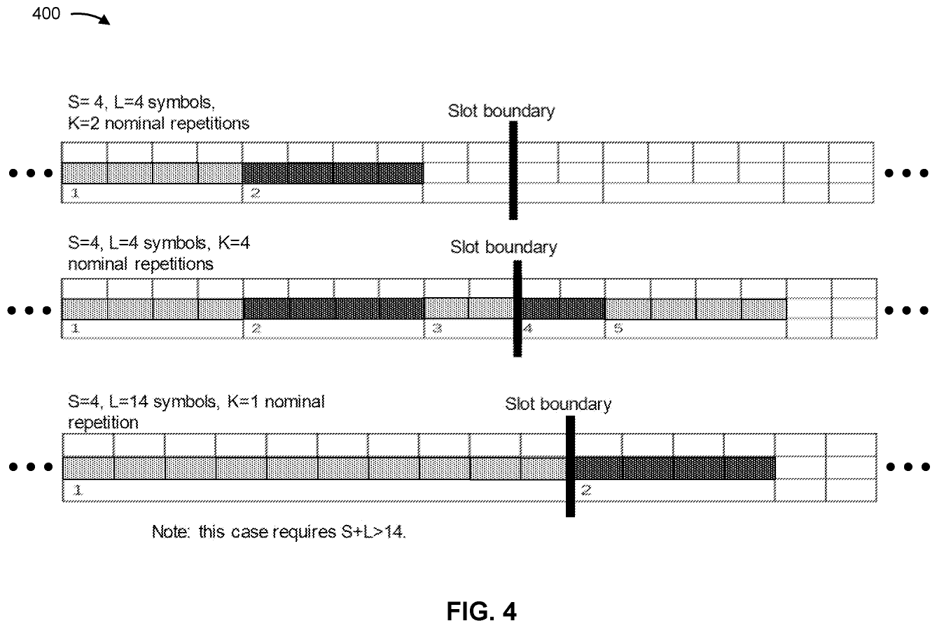

Example 305 is an example of PUSCH repetition Type B. In PUSCH repetition Type B, K nominal repetitions, each repetition having a nominal length L, are scheduled (e.g., in DCI) back-to-back (e.g., consecutively, without a time gap between the repetitions) starting from symbol S, where S and L are indicated by a SLIV. In PUSCH repetition Type B, the scheduled repetitions are referred to as “nominal repetitions” and the indicated length of a repetition is referred to as a “nominal length,” because an actual quantity of repetitions that are transmitted or an actual length of a repetition that is used may differ from the indicated quantity of nominal repetitions or the indicated nominal length of a repetition, as described below in connection with FIG. 4.

As indicated above, FIG. 3 provides examples. Other examples may differ from what is described with regard to FIG. 3.

FIG. 4 is a diagram illustrating an example 400 of physical uplink repetitions, in accordance with various aspects of the present disclosure. Example 400 shows Type B PUSCH repetitions. As described above, a UE may receive an indication (e.g., in DCI) of a quantity of nominal repetitions, of the same length, that are to be transmitted by the UE.

In some aspects, the quantity of actual repetitions transmitted by the UE may be different from the indicated quantity of nominal repetitions. In some aspects, the actual repetitions transmitted by the UE may be different lengths. This may be a result of slot boundaries or invalid symbols. For example, when a nominal repetition crosses a slot boundary, the nominal repetition may be divided into two actual repetitions. As another example, when a nominal repetition is in “invalid symbols,” the nominal repetition may be divided into multiple actual repetitions that avoid the invalid symbols. In some aspects, an invalid symbol may be a downlink symbol (e.g., configured semi-statically for the UE), an indicated symbol of a pattern of invalid symbols, a symbol for synchronization signal block (SSB) reception, or a symbol for monitoring a physical downlink control channel (PDCCH) (e.g., a symbol of a control resource set (CORESET) 0 for Type0-PDCCH monitoring), among other examples.

Example 400 shows three groups of repetitions: a top group, a middle group, and a bottom group. In the top group, two nominal repetitions with a length L of 4 symbols are scheduled. The top group shows two repetitions, where a first repetition has a length L of 4 symbols and a second repetition has a length L of 4 symbols. Thus, the first slot has an actual quantity of 2 repetitions. In the middle group, four nominal repetitions with a length L of 4 symbols are scheduled. The middle group has two actual repetitions in the first slot, of 4 symbols each, but due to a slot boundary, the first slot has a third actual repetition of 2 symbols. The second slot has a fourth actual repetition of 2 symbols and a fifth actual repetition of 4 symbols. In the bottom group, one nominal repetition with a length L of 14 symbols is scheduled. The bottom group has one actual repetition of 10 symbols that fills up the first slot (starting from symbol index 4). The second slot starts with an actual repetition of 4 symbols. In other words, because of slot boundaries, a quantity of actual repetitions may be different from a quantity of nominal repetitions, and repetitions may be of different lengths.

As indicated above, FIG. 4 is provided as an example. Other examples may differ from what is described with regard to FIG. 4.

As indicated above, a base station may schedule or configure uplink transmissions for a UE on an uplink. In some cases, the base station may configure the UE to perform a codebook-based PUSCH transmission, which may be a PUSCH transmission that is configured to be performed in a sounding reference signal (SRS) resource set with a usage of “codebook” configured (e.g., txConfig=“codebook”) for the UE. The SRS resource set may include N SRS resources (e.g., where N=1, 2, 3, or 4), and the base station may configure the quantity of SRS ports and spatial relation information for each of the SRS resources on a per-SRS resource basis.

The spatial relation information for an SRS resource may indicate a reference signal index (e.g., an SSB, a channel state information reference signal (CSI-RS), or another SRS resource) for transmission of the SRS resource (and thus, the associated PUSCH transmission). The UE may use the same spatial domain transmission filter as the reference signal indicated in the spatial relation information (e.g., spatialRelationInfo), which may effectively be an uplink beam for the PUSCH transmission.

The base station may indicate, to the UE, an SRS resource for a PUSCH transmission by indicating the SRS resource in an SRS resource indicator (SRI) field in a downlink communication (e.g., a downlink control information (DCI) communication with a format 0_1, which may be an uplink scheduling DCI) that schedules the PUSCH transmission. The UE may use the same spatial domain transmission filter for the PUSCH transmission as the indicated SRS resource, and may use the quantity of SRS ports of the indicated SRS resource as the quantity of antenna ports for the PUSCH transmission.

In some cases, the downlink communication may further indicate a TPMI and a quantity of layers for the PUSCH transmission. For example, if the downlink communication is a DCI communication, the DCI communication may include a Precoding Information and Number of Layers field (e.g., for DCI format 0_1 or 0_2) that indicates the TPMI and the quantity of layers. The Precoding Information and Number of Layers field may include a codepoint (e.g., a plurality of bits indicating or representing a particular value) that identifies an index associated with a row or column in a table or another type of data structure. The row or column may indicate the quantity of layers and the TPMI that are associated with the index.

The UE may be configured with a plurality of tables of quantities of layers and TPMI indices. The UE may use a configured quantity of antenna ports and a configured Maxrank value (as described below) to identify a table that is to be used by the UE (e.g., each table may correspond to a particular combination of a quantity of antenna ports and a Maxrank value), and may use the index to identify the quantity of layers and the TPMI index. In addition, the UE may be configured with a first set of tables that are used when a FullpowerMode1 parameter (as described below) is not configured for the UE, and a second set of tables that are used when the FullpowerMode1 parameter is configured for the UE. Moreover, the UE may be configured with a plurality of tables of precoding matrices. The UE may use the indicated quantity of layers and a configured quantity of antenna ports to identify a precoding matrix table (e.g., each table may correspond to a particular combination of a quantity of antenna ports and a quantity of layers), and may use the TPMI index to identify a precoding matrix of the identified precoding matrix table. In other words, the same TPMI index may identify different precoding matrices for different tables.

In some cases, the size of the field (e.g., Precoding Information and Number of Layers field) in the DCI may be based at least in part on the quantity of antenna ports indicated for the SRS resource, a Codebooksubset field, a Maxrank field, a TransformPrecoder field, and/or a FullpowerMode1 parameter. The quantity of antenna ports may be used to identify a quantity of rows for an associated TPMI matrix. The Codebooksubset field may indicate whether the antenna ports are fully coherent, partially coherent, noncoherent, or a combination thereof in the case that some antenna ports are pair-wise coherent but not full coherent (e.g., Pair 1 of two antenna ports are coherent, Pair 2 of another two antenna ports are coherent, but Pair 1 and Pair 2 are noncoherent). For example, the Codebooksubset field may indicate that the antenna ports are fullyAndPartialAndNonCoherent, or partialAndNonCoherent (e.g., antenna ports are pair-wise coherent but not full coherent), or noncoherent. In some cases, all TPMI indices that may be indicated by the base station may be used for fullyAndPartialAndNonCoherent antenna ports (which may be referred to as a full coherent subset type), a subset of the TPMI indices may be used for partialAndNonCoherent antenna ports (which may be referred to as a partial coherent subset type), and another subset of the TPMI indices may be used for noncoherent antenna ports (e.g., which may be referred to as a noncoherent subset type).

The Maxrank field may indicate a maximum quantity of layers for the PUSCH transmission. The Maxrank field may be used only if the TransformPrecoder field is not enabled. The TransformPrecoder field may indicate whether DFT-s-OFDM or CP-OFDM is enabled based at least in part on whether the TransformPrecoder field is enabled. The FullpowerMode1 parameter may indicate a particular full power mode that is enabled for the UE. When the FullpowerMode1 parameter is enabled, a UE capable of partial coherency or noncoherency may use TPMI indices for full coherency.

In some cases, a base station may configure a UE to transmit a plurality of repetitions of the same PUSCH transmission (e.g., a plurality of repetitions of the same PUSCH transport block), where each repetition may be directed to a TRP among a plurality of TRPs in a multi-TRP configuration, an antenna panel among a plurality of antenna panels in a multi-panel configuration, or an antenna among a plurality of antennas in a multi-antenna configuration. Thus, if an access link between the UE and a TRP (or antenna panel or antenna) is blocked such that a repetition transmitted to the TRP is not received, another repetition transmitted to another TRP may be received such that the PUSCH transmission can be decoded.

In some cases, the UE may be configured to transmit repetitions of a PUSCH transmission in different time-domain resources (e.g., slots/mini-slots). Each time-domain resource configured for a repetition of the PUSCH transmission may be referred to as a PUSCH transmission occasion. In some cases, the quantity of the repetitions (and thus, the quantity of PUSCH transmission occasions) may be configured via radio resource control (RRC) signaling or may be indicated dynamically (e.g., via DCI or medium access control control element (MAC-CE) signaling) through the use of a time domain resource assignment (TDRA) field. However, the base station may be capable of configuring only one TPMI that is to be used across all repetitions of the PUSCH transmission. If the same TPMI (and thus, the same precoder) is used for repetitions that are directed to different TRPs, antenna panels, or antennas, the transmissions of repetitions may experience reduced performance and/or reliability because channel conditions for the TRPs, antenna panels, or antennas, may be different and not optimally addressed by the same precoder.

Some techniques and apparatuses described herein enable indication of multiple TPMIs in a single DCI. As described above, the single DCI may schedule PUSCH repetitions to multiple TRPs (or antenna panels or antennas). In some aspects, a first field of the DCI may indicate a first TPMI and a quantity of layers. The first field may be a Precoding Information and Number of Layers field, as described above. Accordingly, a size (e.g., a bitwidth) of the first field, and a manner in which the first field is interpreted by a UE, may be in accordance with legacy specifications, as described above. For example, the first TPMI and the quantity of layers may identify a precoding matrix for a first set of repetitions that are to be transmitted. In some aspects, a second field of the DCI may indicate a second TPMI (but not a quantity of layers). A size (e.g., a bitwidth) of the second field, and a manner in which the second field is interpreted by a UE, may be a function of the first field. For example, the second TPMI and the quantity of layers indicated by the first field may identify a precoding matrix for a second set of repetitions that are to be transmitted.

The ability to indicate multiple TPMI indices in a single downlink communication permits the base station to configure a plurality of repetitions of a codebook-based PUSCH transmission to have different precoders and/or other parameters while reducing or minimizing signaling overhead. The ability to configure repetitions of a codebook-based PUSCH transmission to have different precoders and/or other parameters permits the repetitions to be beamformed and/or otherwise optimized for different channel conditions (e.g., multi-TRP channel conditions, multi-panel channel conditions, multi-antenna channel conditions, and/or the like), which increases the performance and reliability of the PUSCH transmissions.

FIG. 5 is a diagram illustrating an example 500 associated with precoding matrix indication for PUSCH repetitions, in accordance with various aspects of the present disclosure. As shown in FIG. 5, example 500 includes communication between a UE 120 and multiple TRPs 505 (shown as a first TRP 505-1 and a second TRP 505-2). In some aspects, the UE 120 and the TRPs 505 may be included in a wireless network, such as the wireless network 100. The UE 120 may communicate with a TRP 505 on a wireless access link, which may include an uplink and a downlink. In some aspects, each TRP 505 may correspond to, may be implemented by, or may be included in, a respective base station 110. In some aspects, the multiple TRPs 505 may be implemented by, or may be included in, the same base station 110. In some aspects, the UE 120 may communicate with multiple antenna panels or multiple antennas of one or more TRPs 505 or base stations 110.

As shown by reference number 510, the UE 120 may receive a DCI message. For example, the UE 120 may receive a single DCI message from the first TRP 505-1 or the second TRP 505-2 (or another TRP or base station). The DCI message may schedule a first set of repetitions of a PUSCH transmission (e.g., a transport block) and a second set of repetitions of the PUSCH transmission. The first set of repetitions may include a first quantity of nominal repetitions, and the second set of repetitions may include a second quantity of nominal repetitions. The first set of repetitions and the second set of repetitions may be Type A or Type B PUSCH repetitions, as described above. For example, the DCI message may schedule the first set of repetitions and the second set of repetitions to be transmitted consecutively (e.g., without time gaps between repetitions), to be transmitted in consecutive slots, and/or to be transmitted in an alternating manner, among other examples.

The DCI message may indicate a first set of transmission parameters for transmitting the first set of repetitions and a second set of transmission parameters for transmitting the second set of repetitions (e.g., the repetitions may be for transmissions to multiple TRPs). The first set of transmission parameters and the second set of transmission parameters may be different (e.g., may differ by at least one transmission parameter). A set of transmission parameters may identify an uplink beam and/or a set of uplink power control parameters, among other examples. Accordingly, in some aspects, the first set of transmission parameters and the second set of transmission parameters may identify different uplink beams and/or different power control parameters. While example 500 will be described in terms of a first set of repetitions and a second set of repetitions, any number of multiple sets of repetitions scheduled with different respective sets of transmission parameters is contemplated.

In some aspects, the DCI message may include two fields that respectively indicate TPMIs for the first set of repetitions and the second set of repetitions. In some aspects, a first field (e.g., a Precoding Information and Number of Layers field) of the DCI message may indicate a TPMI index for the first set of repetitions and a quantity of layers for the first set of repetitions and for the second set of repetitions (e.g., the quantity of layers indicated in the first field is common to the first set of repetitions and the second set of repetitions). In some aspects, a second field of the DCI message may indicate a TPMI index for the second set of repetitions. That is, the second field may not indicate a quantity of layers (e.g., because the quantity of layers for the second set of repetitions is indicated by the first field).

In some aspects, the UE 120 may receive an indication (e.g., an RRC configuration) of whether the second field is to be included in DCI. In some aspects, whether the second field is to be included in DCI may be separately configured for different DCI formats. For example, whether the second field is to be included in DCI may be separately configured for DCI format 0_1 and DCI format 0_2. In some aspects, the UE 120 may receive a DCI message in a DCI format that is not configured to include the second field, and the DCI message may schedule two sets of repetitions (e.g., that use different transmission parameters) of a PUSCH transmission. The UE 120 may use the same precoding matrix for all repetitions (e.g., across both sets of repetitions) when the DCI message does not include the second field.

As shown by reference number 515, the UE 120 may determine sizes of the first field and the second field. For example, the UE 120 may determine a first size of the first field and a second size of the second field. The size of the first field may indicate a quantity of bits (e.g., a bitwidth) of the DCI message allocated for the first field, and the size of the second field may indicate a quantity of bits (e.g., a bitwidth) of the DCI message allocated for the second field. The UE 120 may use the determined sizes of the first field and the second field to identify locations of fields in the DCI message or decode the DCI message, among other examples. In some aspects, a base station 110 (e.g., a TRP 505) may determine sizes of the first field and the second field, as described for the UE 120, and may generate the DCI message based at least in part on the determined sizes.

The UE 120 may determine the size of the first field based at least in part on a quantity of PUSCH antenna ports (e.g., of an SRS resource indicated by the DCI in an SRI field), a codebook subset type (e.g., fullyAndPartialAndNonCoherent, partialAndNonCoherent, or noncoherent, which may be RRC configured), a maximum quantity of layers (e.g., Maxrank), whether a transform precoder (e.g., TransformPrecoder) is enabled, and whether a full power mode (e.g., FullpowerMode1) is enabled, as described above (e.g., according to legacy specifications). The UE 120 may determine the size of the second field based at least in part on the quantity of layers indicated by the first field. In addition, the UE 120 may determine the size of the second field further based at least in part on the quantity of PUSCH antenna ports, whether the full power mode (e.g., FullpowerMode1) is enabled, and/or the codebook subset type.

If the quantity of layers indicated by the first field is 1, the quantity of PUSCH antenna ports (e.g., RRC configured or indicated in an SRI field of the DCI) is 2, and the full power mode is not configured: the size of the second field may be 3 bits (e.g., to enable indication of one of TPMI indices 0-5) for a full coherent subset type (e.g., RRC configured for a Codebooksubset parameter); and the size of the second field may be 1 bit (e.g., to enable indication of one of TPMI indices 0-1) for a noncoherent subset type. If the quantity of layers indicated by the first field is 1, the quantity of PUSCH antenna ports is 2, and the full power mode is configured (e.g., this scenario is only applicable to a noncoherent UE): the size of the second field may be 2 bits (e.g., to enable indication of one of TPMI indices 0-2) for a noncoherent subset type.

If the quantity of layers indicated by the first field is 1, the quantity of PUSCH antenna ports is 4, and the full power mode is not configured: the size of the second field may be 5 bits (e.g., to enable indication of one of TPMI indices 0-27) for a full coherent subset type; the size of the second field may be 4 bits (e.g., to enable indication of one of TPMI indices 0-11) for a partial coherent subset type; and the size of the second field may be 2 bits (e.g., to enable indication of one of TPMI indices 0-3) for a noncoherent subset type. If the quantity of layers indicated by the first field is 1, the quantity of PUSCH antenna ports is 4, and the full power mode is configured (e.g., this scenario is only applicable to a partial coherent UE or a noncoherent UE): the size of the second field may be 4 bits (e.g., to enable indication of one of TPMI indices 0-15) for a partial coherent subset type; and the size of the second field may be 3 bits (e.g., to enable indication of one of TPMI indices 0-3 or 13) for a noncoherent subset type.

If the quantity of layers indicated by the first field is 2 and the quantity of PUSCH antenna ports is 2 (e.g., regardless of whether the full power mode is configured): the size of the second field may be 2 bits (e.g., to enable indication of one of TPMI indices 0-2) for a full coherent subset type; and the size of the second field may be 0 bits (e.g., there is no need for an indication because only TPMI index 0 may be indicated) for a noncoherent subset type. If the quantity of layers indicated by the first field is 2, the quantity of PUSCH antenna ports is 4, and the full power mode is not configured: the size of the second field may be 5 bits (e.g., to enable indication of one of TPMI indices 0-21) for a full coherent subset type; the size of the second field may be 4 bits (e.g., to enable indication of one of TPMI indices 0-13) for a partial coherent subset type; and the size of the second field may be 3 bits (e.g., to enable indication of one of TPMI indices 0-5) for a noncoherent subset type. If the quantity of layers indicated by the first field is 2, the quantity of PUSCH antenna ports is 4, and the full power mode is configured: the size of the second field may be 4 bits (e.g., to enable indication of one of TPMI indices 0-13) for a partial coherent subset type; and the size of the second field may be 3 bits (e.g., to enable indication of one of TPMI indices 0-6) for a noncoherent subset type.

If the quantity of layers indicated by the first field is 3 and the full power mode is not configured (e.g., this scenario is only applicable to the quantity of PUSCH antenna ports being 4): the size of the second field may be 3 bits (e.g., to enable indication of one of TPMI indices 0-6) for a full coherent subset type; the size of the second field may be 2 bits (e.g., to enable indication of one of TPMI indices 0-2) for a partial coherent subset type; and the size of the second field may be 0 bits (e.g., there is no need for an indication because only TPMI index 0 may be indicated) for a noncoherent subset type. If the quantity of layers indicated by the first field is 3 and the full power mode is configured (e.g., this scenario is only applicable to the quantity of PUSCH antenna ports being 4): the size of the second field may be 2 bits (e.g., to enable indication of one of TPMI indices 0-2) for a partial coherent subset type; and the size of the second field may be 1 bit (e.g., to enable indication of one of TPMI indices 0-1) for a noncoherent subset type.

If the quantity of layers indicated by the first field is 4 (e.g., this scenario is only applicable to the quantity of PUSCH antenna ports being 4): the size of the second field may be 2 bits (e.g., to enable indication of one of TPMI indices 0-4) for a full coherent subset type; the size of the second field may be 2 bits (e.g., to enable indication of one of TPMI indices 0-2) for a partial coherent subset type (e.g., regardless of whether the full power mode is configured); and the size of the second field may be 0 bits (e.g., there is no need for an indication because only TPMI index 0 may be indicated) for a noncoherent subset type (e.g., regardless of whether the full power mode is configured).

In some aspects, the sizes of the first field and the second field may be assigned constant values to provide DCI size alignment. For example, DCI size should be constant to enable PDCCH monitoring. DCI size may be constant when the size of a field is based on an RRC configuration, but may not be constant when a size of a field is based on another field in the DCI, as described herein. For example, as described above, the size of the second field may be based at least in part on the quantity of layers indicated by the first field and/or the quantity of PUSCH antenna ports indicated by an SRI field.

In some aspects, the UE 120 may determine the size of the second field based at least in part on the configured codebook subset type and whether the full power mode (e.g., FullpowerMode1) is enabled (e.g., as described above for determining the size of the first field). In some aspects, the UE 120 may determine the size (e.g., the bitwidth) of the second field based at least in part on a maximum quantity of bits needed among all quantities of layers (e.g., 1, 2, 3, and 4 layers) for the quantity of PUSCH antenna ports (e.g., when all SRS resources are configured with the same quantity of ports). For example, as described above (e.g., for a full coherent codebook subset type and when the full power mode is not configured), if the quantity of PUSCH antenna ports is 4 (e.g., all SRS resources are configured with 4 ports), the size of the second field may be 5 bits if the quantity of layers is 1, 5 bits if the quantity of layers is 2, 3 bits if the quantity of layers is 3, and 2 bits if the quantity of layers is 4. Continuing with the previous example, the size of the second field may be the maximum size among all the quantities of layers, which is 5 bits.

In some aspects, the UE 120 may determine the size of the second field based at least in part on a maximum quantity of SRS ports. That is, the UE 120 may determine the size (e.g., the bitwidth) of the second field based at least in part on a maximum quantity of bits needed among all quantities of layers (e.g., 1, 2, 3, and 4 layers) for a maximum quantity of SRS ports (e.g., 4 ports). For example, the UE 120 may use the maximum quantity of SRS ports to determine the size of the second field when at least one SRS resource, in an SRS resource set with usage set to codebook, is configured with a different quantity of SRS ports than at least one other SRS resource in the SRS resource set.

As shown by reference number 520, the UE 120 may determine precoding matrices (e.g., precodings) that are to be used for the first set of repetitions and the second set of repetitions. The UE 120 may determine a first precoding matrix for the first set of repetitions based at least in part on the TPMI index and the quantity of layers indicated by the first field. The UE 120 may determine a second precoding matrix for the second set of repetitions based at least in part on the TPMI index indicated by the second field and the quantity of layers indicated by the first field. As described above, the UE 120 may identify a precoding matrix table, or another data structure, based at least in part on the quantity of layers and the quantity of PUSCH antenna ports (e.g., a quantity that is RRC configured or indicated by an SRI field of the DCI), and may identify a precoding matrix from the identified precoding matrix table using a TPMI index. In some aspects, a base station 110 (e.g., a TRP 505) may determine the first TPMI (e.g., precoding matrix) and the second TPMI (e.g., precoding matrix) that is to be used by the UE 120, and may generate the DCI message (e.g., the values of the first field and the second field) based at least in part on the determined TPMIs.

As shown by reference number 525, the UE 120 may transmit one or more repetitions of the first set of repetitions and the second set of repetitions. That is, the UE 120 may transmit scheduled nominal repetitions of the first set of repetitions and the second set of repetitions as one or more actual repetitions. The UE 120 may transmit repetitions of the first set of repetitions (e.g., nominal repetitions or actual repetitions, as described below) using the first precoding matrix (e.g., using a first precoding) and transmit repetitions of the second set of repetitions (e.g., nominal repetitions or actual repetitions, as described below) using the second precoding matrix (e.g., using a second precoding). Moreover, the UE 120 may transmit repetitions of the first set of repetitions using the first set of transmission parameters (e.g., using a first beam and/or first uplink power control parameters, among other examples) and transmit repetitions of the second set of repetitions using the second set of transmission parameters (e.g., using a second beam and/or second uplink power control parameters, among other examples).

In some aspects, the UE 120 may use the first precoding matrix for transmitting a first set of nominal repetitions, and may use the second precoding matrix for transmitting a second set of nominal repetitions. Here, if a nominal repetition is divided into two actual repetitions (e.g., due to crossing a slot boundary, for example, as shown in the middle group of repetitions of FIG. 4), the UE 120 may use the same precoding matrix for the two actual repetitions. In some aspects, the UE 120 may use the first precoding matrix for transmitting a first set of actual repetitions, and may use the second precoding matrix for transmitting a second set of actual repetitions. Here, if a nominal repetition is divided into two actual repetitions, the UE 120 may use different precoding matrices for the two actual repetitions (e.g., one of the actual repetitions belongs to the first set of repetitions and the other of the actual repetitions belongs to the second set of repetitions).

The UE 120 may transmit repetitions of the first set of repetitions to the first TRP 505-1 (or antenna panel or antenna), and transmit repetitions of the second set of repetitions to the second TRP 505-2 (or antenna panel or antenna). In some aspects (e.g., for Type A PUSCH repetitions), the UE 120 may transmit repetitions of the first set of repetitions and the second set of repetitions in respective consecutive time intervals (e.g., slots). In some aspects (e.g., for Type B PUSCH repetitions), the UE 120 may transmit repetitions of the first set of repetitions and the second set of repetitions consecutively and without time gaps between repetitions. In some aspects, the UE 120 may transmit repetitions of the first set of repetitions and the second set of repetitions in an alternating manner.

As indicated above, FIG. 5 is provided as an example. Other examples may differ from what is described with regard to FIG. 5.

FIG. 6 is a diagram illustrating an example process 600 performed, for example, by a UE, in accordance with various aspects of the present disclosure. Example process 600 is an example where the UE (e.g., UE 120) performs operations associated with precoding matrix indication for.

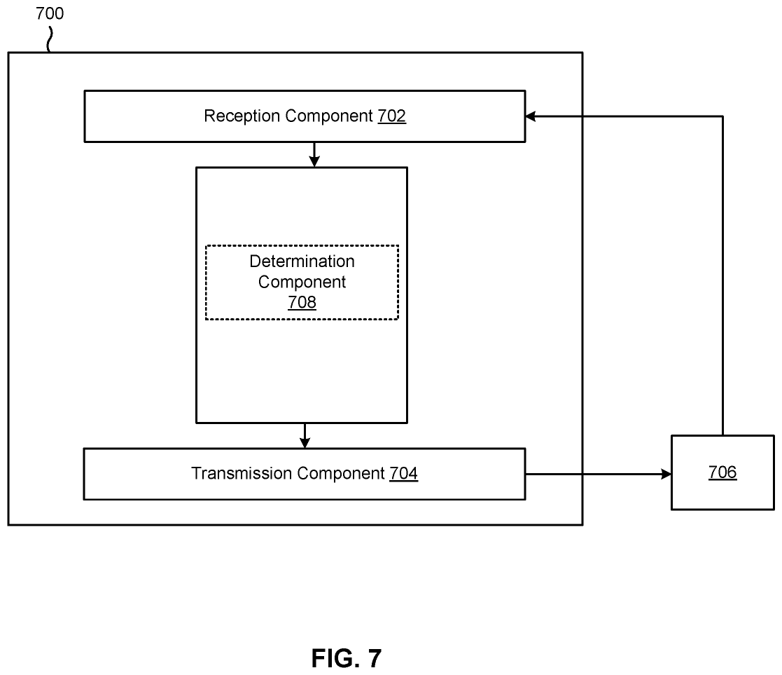

As shown in FIG. 6, in some aspects, process 600 may include receiving a DCI message that includes a first field indicating a first TPMI index and a quantity of transmission layers and a second field indicating a second TPMI index (block 610). For example, the UE (e.g., using reception component 702, depicted in FIG. 7) may receive a DCI message that includes a first field indicating a first TPMI index and a quantity of transmission layers and a second field indicating a second TPMI index, as described above.

As further shown in FIG. 6, in some aspects, process 600 may include determining a first precoding matrix for transmitting a first set of repetitions of a PUSCH transmission based at least in part on the first TPMI index and the quantity of transmission layers, and a second precoding matrix for transmitting a second set of repetitions of the PUSCH transmission based at least in part on the second TPMI index and the quantity of transmission layers (block 620). For example, the UE (e.g., using determination component 708, depicted in FIG. 7) may determine a first precoding matrix for transmitting a first set of repetitions of a PUSCH transmission based at least in part on the first TPMI index and the quantity of transmission layers, and a second precoding matrix for transmitting a second set of repetitions of the PUSCH transmission based at least in part on the second TPMI index and the quantity of transmission layers, as described above.

Process 600 may include additional aspects, such as any single aspect or any combination of aspects described below and/or in connection with one or more other processes described elsewhere herein.

In a first aspect, process 600 includes transmitting one or more repetitions of the first set of repetitions using the first precoding matrix and one or more repetitions of the second set of repetitions using the second precoding matrix.

In a second aspect, alone or in combination with the first aspect, process 600 includes determining a size of the second field based at least in part on the quantity of transmission layers indicated by the first field.

In a third aspect, alone or in combination with one or more of the first and second aspects, the size of the second field is determined further based at least in part on at least one of a quantity of PUSCH antenna ports for the PUSCH transmission, whether a full power mode is configured for the UE, or a codebook subset type configured for the UE.

In a fourth aspect, alone or in combination with one or more of the first through third aspects, process 600 includes determining a size of the second field based at least in part on a maximum quantity of bits used among multiple quantities of transmission layers for a quantity of PUSCH antenna ports for the PUSCH transmission.

In a fifth aspect, alone or in combination with one or more of the first through fourth aspects, process 600 includes determining a size of the second field based at least in part on a maximum quantity of bits used among multiple quantities of transmission layers for a maximum quantity of ports configured for an SRS resource of an SRS resource set configured for codebook usage.

In a sixth aspect, alone or in combination with one or more of the first through fifth aspects, the UE is configured to use the second field for a DCI format associated with the DCI message.

In a seventh aspect, alone or in combination with one or more of the first through sixth aspects, the UE is separately configured for whether the UE is to use the second field for another DCI format.

In an eighth aspect, alone or in combination with one or more of the first through seventh aspects, the first set of repetitions includes a first set of scheduled repetitions and the second set of repetitions includes a second set of scheduled repetitions.

In a ninth aspect, alone or in combination with one or more of the first through eighth aspects, the first set of repetitions includes a first set of transmitted repetitions and the second set of repetitions includes a second set of transmitted repetitions.

Although FIG. 6 shows example blocks of process 600, in some aspects, process 600 may include additional blocks, fewer blocks, different blocks, or differently arranged blocks than those depicted in FIG. 6. Additionally, or alternatively, two or more of the blocks of process 600 may be performed in parallel.

FIG. 7 is a diagram of an example apparatus 700 for wireless communication. The apparatus 700 may be a UE, or a UE may include the apparatus 700. In some aspects, the apparatus 700 includes a reception component 702 and a transmission component 704, which may be in communication with one another (for example, via one or more buses and/or one or more other components). As shown, the apparatus 700 may communicate with another apparatus 706 (such as a UE, a base station, or another wireless communication device) using the reception component 702 and the transmission component 704. As further shown, the apparatus 700 may include a determination component 708, among other examples.

In some aspects, the apparatus 700 may be configured to perform one or more operations described herein in connection with FIG. 5. Additionally, or alternatively, the apparatus 700 may be configured to perform one or more processes described herein, such as process 600 of FIG. 6, or a combination thereof. In some aspects, the apparatus 700 and/or one or more components shown in FIG. 7 may include one or more components of the UE described above in connection with FIG. 2. Additionally, or alternatively, one or more components shown in FIG. 7 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 702 may receive communications, such as reference signals, control information, data communications, or a combination thereof, from the apparatus 706. The reception component 702 may provide received communications to one or more other components of the apparatus 700. In some aspects, the reception component 702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 706. In some aspects, the reception component 702 may include one or more antennas, a demodulator, a MIMO detector, a receive processor, a controller/processor, a memory, or a combination thereof, of the UE described above in connection with FIG. 2.

The transmission component 704 may transmit communications, such as reference signals, control information, data communications, or a combination thereof, to the apparatus 706. In some aspects, one or more other components of the apparatus 706 may generate communications and may provide the generated communications to the transmission component 704 for transmission to the apparatus 706. In some aspects, the transmission component 704 may perform signal processing on the generated communications (such as filtering, amplification, modulation, digital-to-analog conversion, multiplexing, interleaving, mapping, or encoding, among other examples), and may transmit the processed signals to the apparatus 706. In some aspects, the transmission component 704 may include one or more antennas, a modulator, a transmit MIMO processor, a transmit processor, a controller/processor, a memory, or a combination thereof, of the UE described above in connection with FIG. 2. In some aspects, the transmission component 704 may be collocated with the reception component 702 in a transceiver.

The reception component 702 may receive a DCI message that includes a first field indicating a first TPMI index and a quantity of transmission layers and a second field indicating a second TPMI index. The determination component 708 may determine a first precoding matrix for transmitting a first set of repetitions of a PUSCH transmission based at least in part on the first TPMI index and the quantity of transmission layers, and a second precoding matrix for transmitting a second set of repetitions of the PUSCH transmission based at least in part on the second TPMI index and the quantity of transmission layers. In some aspects, the determination component 708 may include a controller/processor, a memory, or a combination thereof, of the UE described above in connection with FIG. 2.

The transmission component 704 may transmit one or more repetitions of the first set of repetitions using the first precoding matrix and one or more repetitions of the second set of repetitions using the second precoding matrix.

The determination component 708 may determine a size of the second field based at least in part on the quantity of transmission layers indicated by the first field. The determination component 708 may determine a size of the second field based at least in part on a maximum quantity of bits used among multiple quantities of transmission layers for a quantity of PUSCH antenna ports for the PUSCH transmission. The determination component 708 may determine a size of the second field based at least in part on a maximum quantity of bits used among multiple quantities of transmission layers for a maximum quantity of ports configured for an SRS resource of an SRS resource set configured for codebook usage.

The quantity and arrangement of components shown in FIG. 7 are provided as an example. In practice, there may be additional components, fewer components, different components, or differently arranged components than those shown in FIG. 7. Furthermore, two or more components shown in FIG. 7 may be implemented within a single component, or a single component shown in FIG. 7 may be implemented as multiple, distributed components. Additionally, or alternatively, a set of (one or more) components shown in FIG. 7 may perform one or more functions described as being performed by another set of components shown in FIG. 7.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method of wireless communication performed by a user equipment (UE), comprising:
receiving a downlink control information (DCI) message that includes a first field indicating a first transmit precoder matrix indicator (TPMI) index and a quantity of transmission layers and a second field indicating a second TPMI index; and
determining a first precoding matrix for transmitting a first set of repetitions of a physical uplink shared channel (PUSCH) transmission based at least in part on the first TPMI index and the quantity of transmission layers, and a second precoding matrix for transmitting a second set of repetitions of the PUSCH transmission based at least in part on the second TPMI index and the quantity of transmission layers.

2. The method of claim 1, further comprising:
transmitting one or more repetitions of the first set of repetitions using the first precoding matrix and one or more repetitions of the second set of repetitions using the second precoding matrix.

3. The method of claim 1, further comprising:
determining a size of the second field based at least in part on the quantity of transmission layers indicated by the first field.

4. The method of claim 3, wherein the size of the second field is determined further based at least in part on at least one of a quantity of PUSCH antenna ports for the PUSCH transmission, whether a full power mode is configured for the UE, or a codebook subset type configured for the UE.

5. The method of claim 1, further comprising:
determining a size of the second field based at least in part on a maximum quantity of bits used among multiple quantities of transmission layers for a quantity of PUSCH antenna ports for the PUSCH transmission.

6. The method of claim 1, further comprising:
determining a size of the second field based at least in part on a maximum quantity of bits used among multiple quantities of transmission layers for a maximum quantity of ports configured for a sounding reference signal (SRS) resource of an SRS resource set configured for codebook usage.

7. The method of claim 1, wherein the UE is configured to use the second field for a DCI format associated with the DCI message.

8. The method of claim 7, wherein the UE is separately configured for whether the UE is to use the second field for another DCI format.

9. The method of claim 1, wherein the first set of repetitions includes a first set of scheduled repetitions and the second set of repetitions includes a second set of scheduled repetitions.

10. The method of claim 1, wherein the first set of repetitions includes a first set of transmitted repetitions and the second set of repetitions includes a second set of transmitted repetitions.

11. A user equipment (UE) for wireless communication, comprising:
a memory; and
one or more processors operatively coupled to the memory, the one or more processors configured to:
receive a downlink control information (DCI) message that includes a first field indicating a first transmit precoder matrix indicator (TPMI) index and a quantity of transmission layers and a second field indicating a second TPMI index; and
determine a first precoding matrix for transmitting a first set of repetitions of a physical uplink shared channel (PUSCH) transmission based at least in part on the first TPMI index and the quantity of transmission layers, and a second precoding matrix for transmitting a second set of repetitions of the PUSCH transmission based at least in part on the second TPMI index and the quantity of transmission layers.

12. The UE of claim 11, wherein the one or more processors are further configured to:
transmit one or more repetitions of the first set of repetitions using the first precoding matrix and one or more repetitions of the second set of repetitions using the second precoding matrix.

13. The UE of claim 11, wherein the one or more processors are further configured to:
determine a size of the second field based at least in part on the quantity of transmission layers indicated by the first field.

14. The UE of claim 13, wherein the size of the second field is determined further based at least in part on at least one of a quantity of PUSCH antenna ports for the PUSCH transmission, whether a full power mode is configured for the UE, or a codebook subset type configured for the UE.

15. The UE of claim 1, wherein the one or more processors are further configured to:
determine a size of the second field based at least in part on a maximum quantity of bits used among multiple quantities of transmission layers for a quantity of PUSCH antenna ports for the PUSCH transmission.

16. The UE of claim 11, wherein the one or more processors are further configured to:
determine a size of the second field based at least in part on a maximum quantity of bits used among multiple quantities of transmission layers for a maximum quantity of ports configured for a sounding reference signal (SRS) resource of an SRS resource set configured for codebook usage.

17. The UE of claim 11, wherein the UE is configured to use the second field for a DCI format associated with the DCI message.

18. The UE of claim 17, wherein the UE is separately configured for whether the UE is to use the second field for another DCI format.

19. The UE of claim 11, wherein the first set of repetitions includes a first set of scheduled repetitions and the second set of repetitions includes a second set of scheduled repetitions.

20. The UE of claim 11, wherein the first set of repetitions includes a first set of transmitted repetitions and the second set of repetitions includes a second set of transmitted repetitions.

21. A non-transitory computer-readable medium storing a set of instructions for wireless communication, the set of instructions comprising:
one or more instructions that, when executed by one or more processors of a user equipment (UE), cause the UE to:
receive a downlink control information (DCI) message that includes a first field indicating a first transmit precoder matrix indicator (TPMI) index and a quantity of transmission layers and a second field indicating a second TPMI index; and
determine a first precoding matrix for transmitting a first set of repetitions of a physical uplink shared channel (PUSCH) transmission based at least in part on the first TPMI index and the quantity of transmission layers, and a second precoding matrix for transmitting a second set of repetitions of the PUSCH transmission based at least in part on the second TPMI index and the quantity of transmission layers.

22. An apparatus for wireless communication, comprising:
means for receiving a downlink control information (PUSCH) message that includes a first field indicating a first transmit precoder matrix indicator (TPMI) index and a quantity of transmission layers and a second field indicating a second TPMI index; and
means for determining a first precoding matrix for transmitting a first set of repetitions of a physical uplink shared channel (PUSCH) transmission based at least in part on the first TPMI index and the quantity of transmission layers, and a second precoding matrix for transmitting a second set of repetitions of the PUSCH transmission based at least in part on the second TPMI index and the quantity of transmission layers.

23. The non-transitory computer-readable medium of claim 21, wherein the one or more instructions, when executed by the one or more processors of the UE, further cause the UE to:
transmit one or more repetitions of the first set of repetitions using the first precoding matrix and one or more repetitions of the second set of repetitions using the second precoding matrix.

24. The non-transitory computer-readable medium of claim 21, wherein the one or more instructions, when executed by the one or more processors of the UE, further cause the UE to:
determine a size of the second field based at least in part on the quantity of transmission layers indicated by the first field.

25. The non-transitory computer-readable medium of claim 21, wherein the one or more instructions, when executed by the one or more processors of the UE, further cause the UE to:
determine a size of the second field based at least in part on a maximum quantity of bits used among multiple quantities of transmission layers for a quantity of PUSCH antenna ports for the PUSCH transmission.

26. The non-transitory computer-readable medium of claim 21, wherein the one or more instructions, when executed by the one or more processors of the UE, further cause the UE to:
determine a size of the second field based at least in part on a maximum quantity of bits used among multiple quantities of transmission layers for a maximum quantity of ports configured for a sounding reference signal (SRS) resource of an SRS resource set configured for codebook usage.

27. The apparatus of claim 22, further comprising:
means for transmitting one or more repetitions of the first set of repetitions using the first precoding matrix and one or more repetitions of the second set of repetitions using the second precoding matrix.

28. The apparatus of claim 22, further comprising:
means for determining a size of the second field based at least in part on the quantity of transmission layers indicated by the first field.

29. The apparatus of claim 22, further comprising:
means for determining a size of the second field based at least in part on a maximum quantity of bits used among multiple quantities of transmission layers for a quantity of PUSCH antenna ports for the PUSCH transmission.

30. The apparatus of claim 22, further comprising:
means for determining a size of the second field based at least in part on a maximum quantity of bits used among multiple quantities of transmission layers for a maximum quantity of ports configured for a sounding reference signal (SRS) resource of an SRS resource set configured for codebook usage.
